(19) United States
(12) Patent Application Publication
(10) Pub. No.: US 2012/0305644 A1
(43) Pub. Date: Dec. 6, 2012

(54) SYSTEM AND METHOD FOR POINT OF SERVICE CARE ACCOUNTABILITY, MONITORING AND REPORTING

(76) Inventor: Malcolm C. Daniels, JR., Phoenix, AZ (US)

(21) Appl. No.: 13/544,290

(22) Filed: Jul. 9, 2012

Related U.S. Application Data
(63) Continuation-in-part of application No. 13/153,555, filed on Jun. 6, 2011.

(51) Int. Cl. G06K 5/00

(52) U.S. Cl. 235/380

(57) ABSTRACT

A system is disclosed for insuring accountability of a provider at a point of service. The system comprises a card holder identification card having a printed code identifying the card holder. A processing device at the point of service is programmed to read the card holder's code and establish communication with the code server to transfer the card holder's code to the code server. The code server is programmed to compare the received code to the code database and return the address corresponding to the received code to the processing device. The processing device is programmed to use the return address to download the personal identification information defining card holder eligibility for display at the point of service and thereafter the processing device communicates with the application database indicating one performance of the service begins and ends.

### CROSS REFERENCE TO RELATED APPLICATIONS

This application is a continuation-in-part of application Ser. No. 13/153,555 filed Jun. 6, 2011.

### FIELD OF THE INVENTION

The present invention relates to a means and method for transmitting personal identification and other pertinent identifiable information, relative to eligibility as a recipient of Medicaid or other insured services, or the like, from a select database to a Medicaid, private insurance or other provider of services, and to providing accountability of the service provider.

### BACKGROUND OF THE INVENTION

Congress created Medicaid in 1965 as Title XIX of the Social Security Act. Each state administers its own Medicaid program. The federal Centers for Medicare and Medicaid Services (CMS) monitor state-run programs and establish requirements for service delivery, quality, funding, and eligibility standards. Medicaid is voluntary for states, but every state participates.

State Governments are responsible for establishing and enforcing the standards mentioned above of a resident's eligibility, validation and use of Medicaid and Social Services and programs. Most States implement and accomplish this through the issuance of State Medicaid ID cards which usually do not include a photo of the approved recipient and are otherwise limited in the amount of identifying information.

Particularly, each State in the Union has similar obligations to its citizens, one of which is health care. Medicaid is the provision of health care to those citizens of the State who have no health insurance or other means to pay for it. The timely accessibility of correct eligibility information and certification is absolutely essential to the rightful delivery of competent health care at all times, whether the care is delivered under private or public programs.

A chief source of pressure on State budgets is the growth of state Medicaid costs for lower income citizens. In terms of overall Medicaid fraud, card sharing and phantom billing account for as much as $60 billion of current Medicaid costs. Medicaid fraud has two aspects: one, by the patient—attempting to receive care but not eligible due to ineligibility or illegality as in not being a citizen, and two, by the provider—through billing the system improperly for services rendered.

The present invention is directed to overcoming the problems discussed above.

### SUMMARY OF THE INVENTION

In accordance with the invention, a system and method are provided for insuring accountability of a provider at a point of service.

In accordance with one aspect of the invention there is disclosed a method for insuring accountability of a provider at a point of service using eligibility information stored at a select application database, comprising the steps of providing an individual with an identification card having a code identifying the card holder; operating a code database correlating card holder specific codes and corresponding addresses associated with the select application database; operating a processing device at the point of service to read the card holder's code and operatively communicate with the code database to compare the received code to the code database and determine the address corresponding to the received code; operating the processing device to use the determined address to download eligibility information from the select application database for display on the processing device at the point of service, and thereafter the processing device communicating with the select application database indicating when performance of the service begins and ends; and operating the select application database to store data from the processing device.

In accordance with another aspect of the invention, there is disclosed a system for insuring accountability of a provider at a point of service using personal identification information stored at a select application database. The system comprises a card holder identification card having a printed code identifying the card holder. The code server comprises a code database correlating card holder's specific codes and corresponding addresses associated with the select application database. A processing device at the point of service is programmed to read the card holder's code and establish communication with the code server to transfer the card holder's code to the code server. The code server is programmed to compare the received code to the code database and return the address corresponding to the received code to the processing device. The processing device is programmed to log onto the application database and use the return address to download the personal identification information defining card holder eligibility for display on the processing device at the point of service and thereafter the processing device communicates with the application database indicating when performance of the service begins and ends. The application database is adapted to store data from the processing device.

It is a feature of the invention that the printed code comprises a three dimensional bar code.

It is another feature that the processing device comprises an activity application and the provider activates a check in function on the processing device when performance of the service begins and activates a check out function on the processing device when performance of the service ends.

It is still another feature that the processing device establishes communication with the code database over a computer network.

It is a further feature of the invention that the application database stores time when performance of the service begins and ends and location of the point of service. The application database may store location using GPS data from the processing device.

It is a further feature of the invention that the application database periodically accesses location data from the processing device while the service is being performed. The application database may determine if location of the processing device has moved from the location where performance of the service began.

It is an additional feature of the invention that where upon completion of the service the application database transfers a form to the processing device and the provider fills in the form to identify services performed. The filled in form may be transferred from the processing device to the application database for storage.

Further features and advantages of the invention will be readily apparent from the specification and from the drawings.

### BRIEF DESCRIPTION OF THE DRAWINGS

FIG. 1 is a generalized view of an identification card having a printed code identifying the card holder in accordance with the invention;

FIG. 2 is a block diagram of a system for insuring accountability of a provider at a point of service in accordance with the invention; and

FIGS. 3-7 comprise a flow diagram illustrating operation of the system of FIG. 2.

### DETAILED DESCRIPTION OF THE INVENTION

The application is described in detail relative to its use with a Medicaid program but the system and method described herein can be used for any and all eligibility and accountability needs for, including but not limited to, government, public and private companies, insurers, and other providers of services and programs.

The invention disclosed herein comprises a means and method for transmitting eligibility information relative to eligibility as a recipient of Medicaid or other insured services from a select database, such as a State computer system, to a Medicaid, private insurance or other provider of services. An individual's eligibility information is stored in the State's computer system, and the information is sent to authorized users as needed. The card holder is provided a URL that is assigned to a bar code that responds to a form of bar code recognition technology. The bar code can be scanned by appropriate personnel with an appropriate scanner or other digital imaging device. The scanned bar code is authenticated by the scanning device's application and code sever, and the information corresponding to that individual recipient is sent back to the scanning device for use by the appropriate personnel. The eligibility information is sent to any approved party authorized to receive it. The entire process requires authentication of the requesting personnel and validation of the bar code for security purposes.

Moreover, the system and method disclosed herein automatically notifies, documents and reports to the State system each time a home healthcare employee enters and exits a predetermined permitted location where they have “checked in” or “checked out,” and indicates whether the employee's stay is consistent with the timeframe within which they are required to perform their contracted services for a Medicaid recipient. Should the employee leave the location during this timeframe for any reason once “checked-in”, the system will record that event and report it to the State. The distance from the point of service can be predetermined as a perimeter, e.g., ½ mile. To discourage employee circumvention of the perimeter notification feature (by intentionally leaving their smart phone on the premises, for example), the system may also includes logic that randomly sends calls or text messages that require a response from the provider.

The system disclosed herein comprises a unique mobile solution which utilizes any Smartphone carried by a provider, such as a home healthcare (HHC) provider. The system monitors the location, timing and on-site delivery of home care, insuring timely services and support for patients. HHC providers pay all program fees and a significant portion of these fees is paid to the State, replacing program costs with a substantial new state revenue stream. Key Program Benefits include: delivery of home care is monitored and dramatically improved; fraud and expense is reduced; Medicaid costs are reduced during a time of extreme budget pressures; and the State participates in a new revenue stream.

The system uses a simple user interface. A unique Microsoft High Capacity Bar Code (TAG) is printed on a card issued to each HHC recipient. TAGs are provided free of cost to the State. The HHC provider simply scans the TAG with his/her Smartphone at time of arrival and departure at the service delivery location. The system “reads” the TAG and securely reports critical information regarding the service visit. By simply scanning the TAG the system is able to record and display the following application functionality in real time:
A “Check-In” bar enabling the worker to log in to the system
Full name and current home address of the HHC recipient
Recipient ID—an ID number uniquely assigned to each individual HHC recipient Group ID—an ID number for a group or sub-division of the eligible HHC population
Code ID—the unique individual TAG or Bar Code assigned to each individual recipient
HHC Worker ID—a unique ID assigned to each specific home health employee Name and phone number of recipient's next of kin.
Name and phone number of recipient's primary care physician
A “Check out” bar used by the worker to log out of the system at completion of service delivery
   The system also includes real-time record keeping capabilities, including:
Recipient's full name and current home address
Recipient ID
Group ID—Code ID
Scan Time—the Date and Time of the TAG Scan accurate to milliseconds
Device ID—a unique identifier for the scanning device
Employee ID—specific home health employee identified by Device ID
LNG—the longitude of the scanning device
LAT—the latitude, of the scanning device
Postal Code—the Postal Code (Zip) of the scanning device.

In accordance with the invention, an unique individualized three-dimensional (3D) color barcode, using X and Y positioning with a color as the Z value, is printed on each State issued Medicaid ID card (as will be apparent, the present invention is not limited to use with 3D bar codes). This gives the State the ability to include and deliver information to a provider of Medicaid services and other appropriate authorized parties. The information delivered by the attendant application through use of the bar code can be continually and automatically updated, changed, modified or amended, can increase/decrease the number of personal identifiers and/or change the eligibility status, validate and approve use status of the card holder in real time. Therefore, the invention accomplishes: (i) eliminating the possibility of someone falsely claiming to be eligible for Medicaid and other services and wrongfully receiving such services provided through the State; and, (ii) eliminating the need and cost of cancelling ID cards when the card holder is no longer approved to receive the services and having to reissue a new ID card when they become eligible to again receive such services; (iii) eliminating the cost of printing new ID cards for eligibility on a monthly basis; and, (iv) insures that a card holder receives the benefit of other services and government programs he/she is entitled to participate in by identifying, tracking and verifying the card holders participation in other governmental funded services and programs designed to provide the card holder with needed additional services he/she is entitled to receive.

In using 3D bar codes with bar code recognition technology, the systems and methods described herein will interface with the State's network of secured computer systems. The State will be enabled to; (i) provide current and updated personal identifiers indicating the eligibility for services status of each card holder; (ii) track the card holders visits for Medicaid and other Social Service and programs participation; and, (iii) can link and share a card holder's eligibility information with other state and local government databases.

As described more particularly below, the system implements an application that processes the bar code image and outputs a code record ID. This ID is transmitted to a code server through the use of, for example, a camera equipped mouse or a webcam attached to a PC, or other digital imaging device, using the web or secure network connection to access the eligibility information. The code server determines the Content Location Value (URL) associated with the code record ID and transmits it back to the application. The application launches the device's browser with the URL and connects to the appropriate computer system for the State's Medicaid system, or the like. Information is retrieved from Internal Content Database(s) located on the State's server(s) connected to secure internal network; and, if required, External Content Database(s) located on other State or local government servers connected to secure external networks or the internet. Eligibility information is retrieved from the Database(s) and assembled into single presentation layer. Assembled information is transmitted back to the requesting device—a PC or mobile device using the web or secure network connection to the State and local government servers to access the requested information.

The printed 3D bar code, requesting device and application do not contain or retain any of the information provided from the State government computer systems. Once viewing the information has been completed, the secured network connection is terminated and all information remains in the State secured computer systems.

The disclosed solution comprises a “pro-active” approach to the problem of Medicaid Fraud that focuses on certifying card holder eligibility to reduce fraud. In an exemplary embodiment, the system uses 3D color bar code recognition technology and printed 2D and/or 3D color bar codes to certify eligibility at the point of service and prior to delivery of service.

Particularly, the system utilizes printed codes on Medicaid Identification Cards—codes that when “read” by a mobile device, or computer connected to a webcam, camera equipped mouse or other digital imaging device, provides access to card holder information and displays it on a viewable screen. The solution is superior in terms of cost and ease of management to so-called “smart cards” which require costly “readers” on the desks of the providers and/or software that requires expensive provider training and implementation.

This approach gives states an efficient, effective and economical way to identify and certify that a card holder is, in fact, eligible for benefits. In so doing, it offers states another way to help solve the problem of Medicaid Fraud and produce sizable savings for state Medicaid programs.

The system includes built-in tracking, metrics and analytic tools. The 3D bar code is used to give users, companies, governmental agencies and individuals access to data that can help them make effective decisions about information processing and expenditures. The systems dynamic technology allows changes of information at any time, enabling States to react and evolve in real-time and deliver up-dated correct and timely data.

The 3D bar code decoding module is composed of a set of image processing, analyzing and decoding algorithms for distribution on mobile devices or computers. The decoding module operates under various lighting conditions through the use of a low-cost digital camera, limited processing power and memory usage of mobile phones, such as smart phones, or computers.

Unlike 2D barcodes which are presented in black and white, the 3D bar codes can be generated in a combination of black, white and various other color combinations and can be expressed in various designs according to changes in color and shape cells.

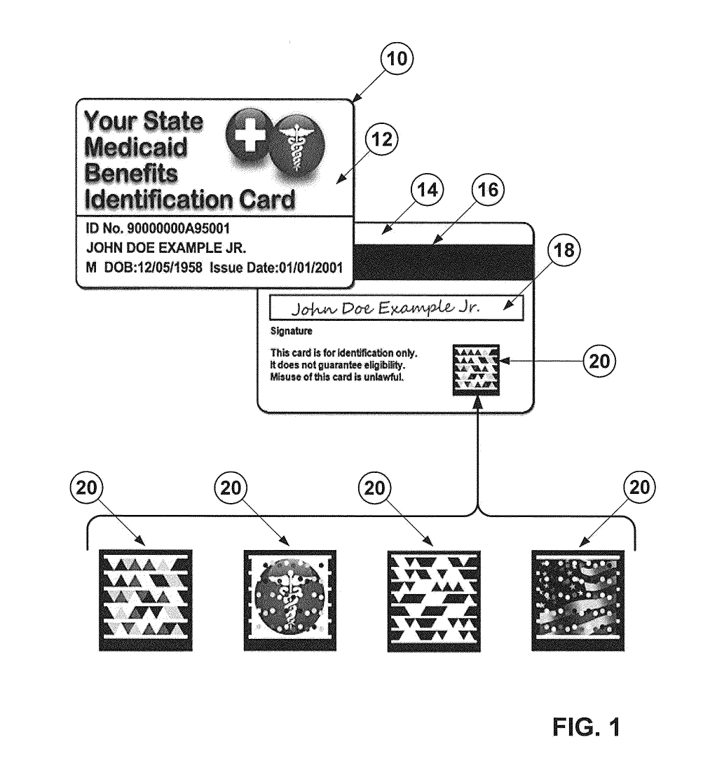

FIG. 1 illustrates an ID card 10 for use with the system and method in accordance with the invention. In the illustrated embodiment of the invention, the ID card 10 comprises a State Medicaid benefits identification card. The card includes a front side 12 and a back side 14. The front side 12 may include an ID number for the card holder, the card holder's name, date of birth and issue date. The back side 14 may include a conventional encoded magnetic stripe 16, a signature block 18 and a printed code 20 identifying the card holder. There are numerous different types of printed codes that can be used, such as a standard 2D bar code. In accordance with the invention, the printed code 20 may be a 3D color bar code using X and Y positioning with a color as the Z value on the card. The printed code can be decoded to provide a code record ID associated with the card holder. The printed code 20 may take one of numerous different forms, as illustrated. The present invention is not directed to the printed code specifically, but rather to a system and method which uses the printed code to determine eligibility of a card holder possessing the ID card 10 at a point of service.

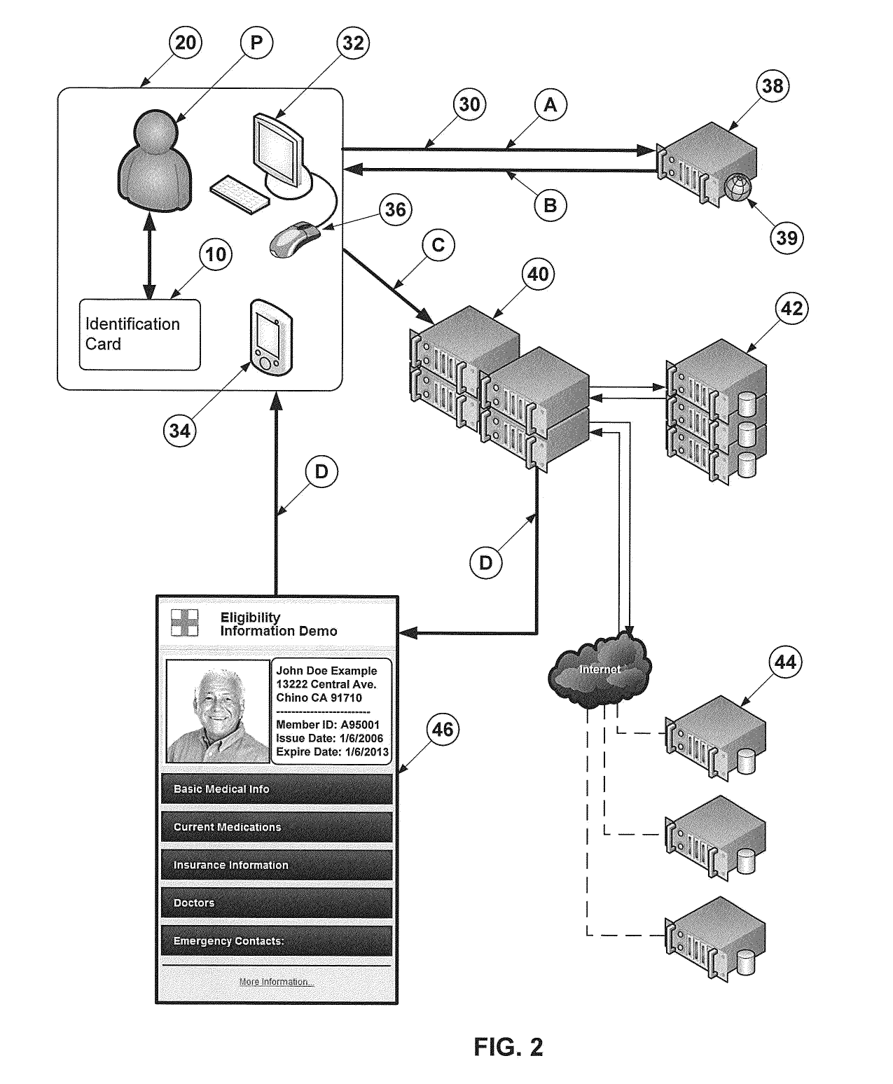

Referring to FIG. 2, a block diagram illustrates a system 30 in accordance with the invention for insuring accountability of a service provider at a point of service 20. The point of service 20 can be, for example, a physician's office, a hospital or other medical facility, or any location of an emergency service provider or the like. Additionally, a Medicaid and Medicare home health benefit is crucial to many beneficiaries, allowing them to recuperate in the comfort of their own homes. Thus, the point of service may be a home or other location of the patient. However, as fraud is a major concern, the system and method disclosed herein can verify and authenticate home visitations by location and time spent.

The ID card 10 is presented to a provider P. The provider P will have access to a conventional computer 32 or smart phone 34, or the like. The computer 32 may include a mouse 36 having a built in camera, or a separate webcam, or other digital imaging device. The smart phone 34 will have a camera. Either the smart phone 34 or the personal computer 32 will include a code reader application or “app” configured to operate in the system 30. The code reader app is adapted to read the printed code 20, see FIG. 1. Particularly, the computer 32 or smart phone 34 reads the printed code so that the information encoded into the printed code becomes available on the computer 32 or smart phone 34.

As will be apparent, the computer 32 can be a desktop computer, a laptop computer or any other type of computer capable of having an image reading input device for scanning the printed code 20 and performing the processing required to implement the functionality described herein. Likewise, the smart phone 34 can be of any conventional design also capable of performing the processing required to implement the functionality described herein.

The computer 32 and/or the smart phone 34 are operatively connected to a code server 38. The code server 38 comprises a programmed computer or device on a network that manages files stored on a code database 39. The code server 38 includes built-in tracking, metrics and analytic tools. The connection between the point of service 20 and the code server 38 may be provided via any available communication network, such as a cellular phone network, a computer network, including the Internet, or various other means for communication. The code server 38 includes the code database 39 which correlates card holder specific code record ID numbers and corresponding URL addresses. Each URL address is associated with an application server 40 and includes identifying information for the card holder. This identifying information is used to access eligibility information. As will be apparent, each State Medicaid office, private insurer, or other provider of services may have its own independent application server. Only one application server 40 is illustrated herein.

The application server 40 is operatively connected to the computer 32 and/or smart phone 34, via any known communication means, as with the code server 38. The application server 40 is programmed to retrieve information regarding the card holder and eligibility of the card holder for a particular good or service. The application server 40 is described herein in the context of a State Medicaid eligibility function. As such, the application server 40 would be operated by the State and retrieve eligibility information for authorized card holders. The application server 40 utilizes Internal Content Databases 42 and External Content Databases 44. As will be appreciated, the application server 40 and Content Databases 42 and 44 would be operated by the entity providing eligibility information.

Information flow using the system 30 is now described. Initially, the eligibility ID card 10 is presented and scanned by the camera equipped mouse 36, or webcam, or smart phone 34, or other digital imaging device. The code reader application processes the printed code 20, to determine the code record ID and initiates a communication channel with the code server 38 over lines A and B. The code reader app outputs the code record ID on the line A to the code server 38. The code server 38 accesses its code database 39 and determines the content location value (URL) associated with the code record ID and transmits the URL back to the code reader app on the line B. The code reader app launches the device's browser with the URL and connects it to the appropriate application server 40 on a line C. The application server 40 retrieves eligibility information from the Content Databases 42 and/or 44 and assembles the information into a single presentation layer. Once the information is retrieved by the application server 40, the assembled information is transferred on a line D back to the point of service 20 for display on the smart phone 34 or computer 32. An example of eligibility information for display is shown at 46. This displayed information can include a photograph of the card holder along with generalized information such as name, address, member ID, issue date and expiration date along with medical information as necessary or desired. The provider P at the point of service 20 can use this information to verify eligibility and that the information is consistent with the information provided on the ID card 10 and the photograph matches the card holder in possession of the ID card 10.

Using an activity application, activities of the health provider in providing the eligible services are monitored via the smart phone 34. The smart phone scans the user code upon arrival and departure. The system, using the phone's GPS and clock functions can capture exact location and time of visit to serve as proof of the visit which can be reported to the state or other provider to authenticate reimbursement.

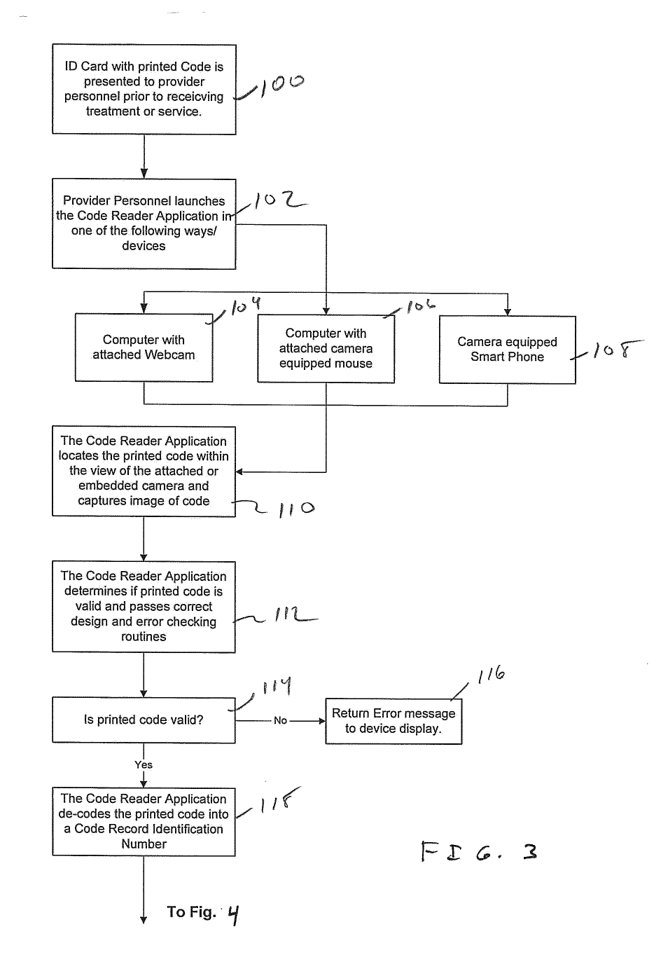

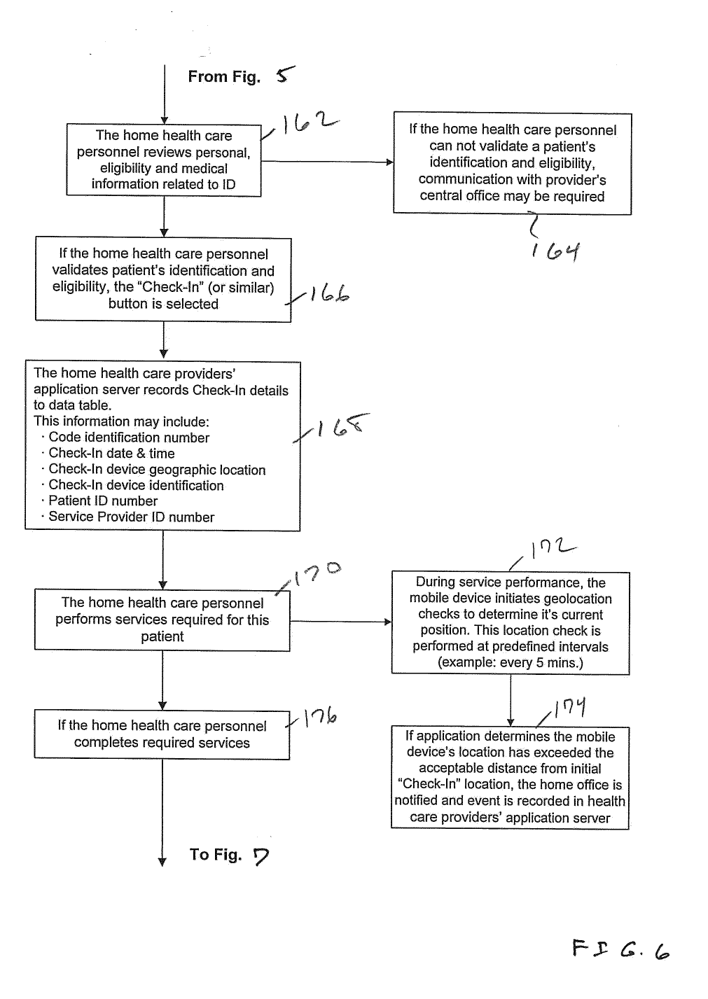

FIGS. 3-7 comprise a flow diagram illustrating sequence of operation for the various programs on the computer 32, the smart phone 34, the code server 38 and the application server 40 for transmitting personal identification information, relative to eligibility as a recipient of Medicaid or other insured services, from a select database to a provider of services and to insure accountability of the provider.

The process begins at a block 100 where an ID card 10 with a printed code 20 is presented to provider personnel P prior to receiving treatment or service. The provider personnel P use the ID card 10 to obtain the eligibility information as described herein, rather than relying simply on the identity of the card holder. The provider P launches the code reader application at a block 102. The code reader application can be launched on a computer with attached web cam at a block 104, a computer with attached camera equipped mouse at a block 106 or a camera equipped smart phone 108. At a block 110, the code reader application locates the printed code 20, see FIG. 1, within the view of the attached or embedded camera and captures an image of the printed code. The code reader application determines if the printed code 20 is valid at a block 112 and that it passes correct design and error checking routines conventional for such printed codes 20. A decision block 114 determines if the printed code is valid. If not, an error message is returned to the device display at a block 116 and the routine ends. If the printed code 20 is valid, then the code reader application decodes the printed code into a code record ID number at a block 118.

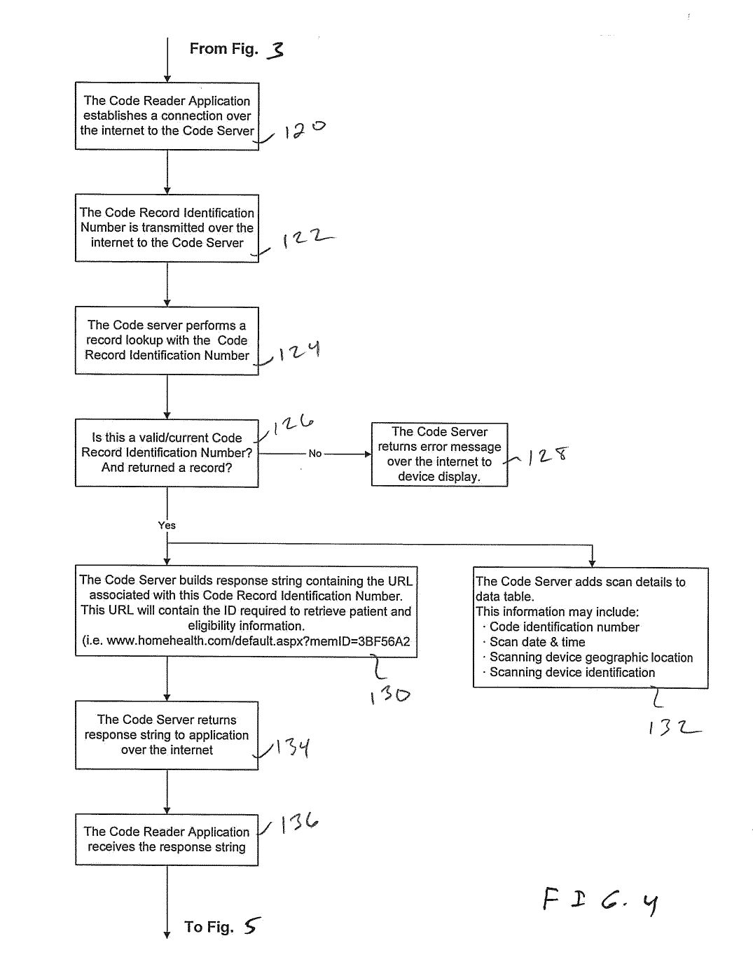

Moving to FIG. 4, from the block 118, the code reader application establishes a connection over the Internet, or otherwise, with the code server 38 at a block 120. The code reader application transmits the code record ID number to the code server 38 at a block 122. At a block 124, the code server 38 performs a record look up in its code database 39 using the code record ID number. A decision block 126 determines if the code record ID number is valid and current. The code server 38 also determines if a record has been returned. If not to any of these options, then the code server 38 returns an error message to the code reader application at a block 128 and the routine ends. If the code record ID number is valid and current and a record has been returned, then the code server 38 builds a response string containing the URL associated with this code record ID number at a block 130. The URL will contain the ID required to retrieve eligibility information for the card holder, as shown. The code server 38, at a block 132, will add scan details to the code database 39. This information may include the code record ID number, the scan date and time, the geographic location of the computer 32 or smart phone 34 as well as a unique scanning device identification code. This information can be used as a record of how and when the system 30 has been accessed.

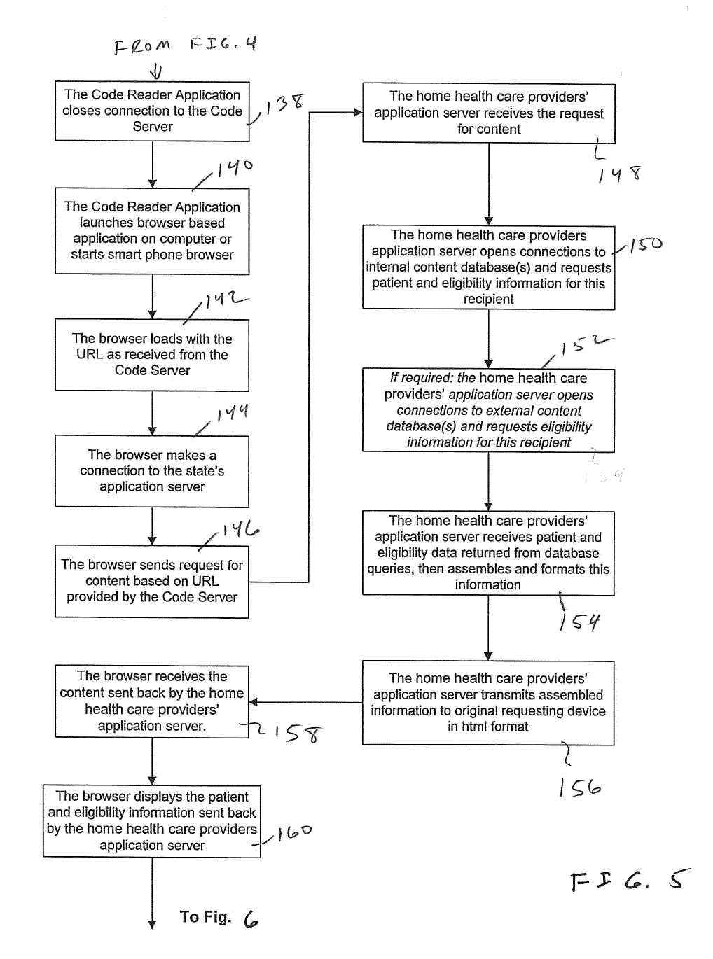

The code server 38 returns the URL response string to the code reader application at a block 134. The code reader application receives the response string at a block 136. The program flow proceeds to FIG. 5.

At a block 138, the code reader application closes the connection to the code server 38. The code reader application then launches a browser based application on the computer 32 or starts the smart phone browser at a block 140. At a block 142 the browser loads the URL received from the code server 38 and the browser makes a connection to the State's application server 40 at a block 144. The browser sends a request for content, based on the URL provided by the code server 38, at a block 146. This request for content is received by the State's application server 40 at a block 148. The State's application server 40 opens connections to the Internal Content Databases 42 and requests eligibility data for the card holder at a block 150. If required, then the State's application server 40 opens connections to the External Content Databases 44 and requests eligibility data therefrom for the card holder at a block 152. The eligibility data is received by the State's application server 40 at a block 154. This data can be from database queries to any of the Content Databases 42 or 44. The State's application server 40 assembles and formats this data which is transmitted to the requesting device in HTML format at a block 156. The browser at the computer 32 or smart phone 34 receives the content sent back by the State's application server 40 at a block 158 and displays the eligibility information, see 46 at FIG. 2, at a block 160.

The smart phone 34 also implements an activity application once eligibility has been verified. This is used to insure accountability of the provider at the point of service.

Beginning at a block 162, the home health care personnel provider reviews personal, eligibility and medical information related to the ID for the patient. If identification and eligibility cannot be validated, then the provider may communicate with the provider's central office, as noted at a block 164. If the provider is able to validate the patient's ID, then the provider can begin performing the service. This is initiated by, for example, activating a “check in” button in the activity application on the smart phone 34. This is done at a block 166. Necessary information is transmitted to the application server 40 at a block 168 which records check in details to an application database. These details may include the code identification number, the check in date and time, the geographic location of the check in device, the identification of the check in device, the patient ID number and the service provider ID number. The geographic location information is derived from GPS location data from the smart phone 34.

The home health care provider then performs the required services for the patient, as indicated at block 170. While the service is being performed, then the smart phone may periodically initiate geolocation checks to determine current position. This may be performed at predefined intervals, such as every five minutes, as noted at a block 172. If the activity application determines that the smart phone's location has exceeded an acceptable distance from the check in location, then a message is transmitted to the application server 40 so that the home office is notified and the event is recorded in the health care provider's application server 40.

Once the required services have been completed, as noted at the block 176, then the provider selects a “check out” button on the smart phone 34. The check out function can also be initiated by the service provider scanning the patient's ID card. Check out details are then transferred to the application server 40 for storage in the application database. This may include information similar to that transferred at check in as discussed above relative to the block 168. The home health care provider's application server may deliver a check out form to be completed by the service provider at a block 182. The attending provider is able to make notes about the visit and report any information required by the State to be stored in a database for as long as desired. The form may include, for example, a description of services performed, a check list of CPT codes, notes on the patient and/or the visit, list of equipment used during the visit or delivered. The home health care provider can then fill in and submit the form using the check out button or another function on the smart phone 34 at a block 184. The submitted information is stored within the home health care provider's application database at a block 186 and the process ends.

The application server database may include the content of the notes and form fields submitted by the provider along with user ID of the provider, patient ID of the visit, a visit ID, device ID, date and time of submission and geolocation based on latitude and longitude of the device at the time of submission.

There are various levels of security provided in the disclosed system. The actual URL of the content resides in the code server 38 and not within the printed code 20. Thus, no information is revealed if someone decodes, hacks or reverse engineers the printed code 20. It is simply a record number which is provided to the code server 38. Data transferred to and from the State's application server 40 can be secured by SSL certificates, and/or encrypted. These devices would utilize existing security framework in place for Internet and network access. Likewise, the personnel provider P may be required to log, into the State's application server 40 using a user ID and password. This log in can be provided as part of the browser making a connection to the State's application server at the block 144, see FIG. 5, as will be apparent.

Using bar code recognition technology in concert with the disclosed eligibility and identity verification application, can help prevent fraud costs in these areas. The code reader application enables card holder eligibility confirmation for Medicaid recipients at point of service. The bar code (printed in ink on paper or a card) can be scanned by a cell phone camera, web-cam or a very inexpensive mouse with an embedded camera. This eliminates the need for expensive bio-metric or smart cards and readers.

The system accesses securely stored data on remote servers and displays that data on a computer screen or phone screen. The data can include photographs and other data unique to an eligible recipient. The data can be revised or updated and accessible in real time to deliver updated, correct, and timely data. The 3D bar code only contains digital pathway information. Content resides in the State's application server, under the State's control, thus eliminating many concerns about security and privacy.

The present invention has been described with respect to flowcharts and block diagrams. It will be understood that each block of the flowchart and block diagrams can be implemented by computer program instructions. These program instructions may be provided to a processor to produce a machine, such that the instructions which execute on the processor create means for implementing the functions specified in the blocks. The computer program instructions may be executed by a processor to cause a series of operational steps to be performed by the processor to produce a computer implemented process such that the instructions which execute on the processor provide steps for implementing the functions specified in the blocks. Accordingly, the illustrations support combinations of means for performing a specified function and combinations of steps for performing the specified functions. It will also be understood that each block and combination of blocks can be implemented by special purpose hardware-based systems which perform the specified functions or steps, or combinations of special purpose hardware and computer instructions.

I claim:

1. A method for insuring accountability of a provider at a point of service using eligibility information stored at a select application database, comprising the steps of:
providing an individual with an identification card having a code identifying the card holder;
operating a code database correlating card holder specific codes and corresponding addresses associated with the select application database;
operating a processing device at the point of service to read the card holder's code and operatively communicate with the code database to compare the received code to the code database and determine the address corresponding to the received code;
operating the processing device to use the determined address to download eligibility information from the select application database for display on the processing device at the point of service, and thereafter the processing device communicating with the select application database indicating when performance of the service begins and ends; and
operating the select application database to store data from the processing device.

2. The method of claim 1 wherein the printed code comprises a three dimensional bar code.

3. The method of claim 1 wherein communicating with the application database to indicate when performance of the service begins and ends comprises the provider activating a check in function on the processing device when performance of the service begins and activating a check out function on the processing device when performance of the service ends.

4. The method of claim 1 wherein the processing device establishes communication with the code server over a computer network.

5. The method of claim 1 wherein the application database stores time when performance of the service begins and ends and location of the point of service.

6. The method of claim 5 wherein the application database stores location using GPS data from the processing device.

7. The method of claim 1 wherein the application database periodically accesses location data from the processing device while the service is being performed.

8. The method of claim 7 wherein the application database determines if location of the processing device has moved from the location where performance of the service began.

9. The method of claim 1 wherein upon completion of the service the application database transfers a form to the processing device and the provider fills in the form to identify services performed.

10. The method of claim 9 wherein the filled in form is transferred from the processing device to the application database for storage.

11. A system for insuring accountability of a provider at a point of service using personal identification information stored at a select application database, comprising:
a card holder identification card having a printed code identifying the card holder;
a code database correlating card holder specific codes and corresponding addresses associated with the select application database;
a processing device at the point of service being programmed to read the card holder's code and operatively communicate with the code database to compare the received code to the code database and determine the address corresponding to the received; and
the processing device is programmed to log onto the application database and use the determined address to download the personal identification information defining card holder eligibility for display on the processing device at the point of service and thereafter the processing device communicating with the application database indicating when performance of the service begins and ends; and
the application database is adapted to store data from the processing device.

12. The system of claim 11 wherein the printed code comprises a three dimensional bar code.

13. The system of claim 11 wherein the processing device comprises an activity application and the provider activates a check in function on the processing device when performance of the service begins and activates a check out function on the processing device when performance of the service ends.

14. The system of claim 11 wherein the processing device establishes communication with the code server over a computer network.

15. The system of claim 11 wherein the application database stores time when performance of the service begins and ends and location of the point of service.

16. The system of claim 15 wherein the application database stores location using GPS data from the processing device.

17. The system of claim 11 wherein the application database periodically accesses location data from the processing device while the service is being performed.

18. The system of claim 17 wherein the application database determines if location of the processing device has moved from the location where performance of the service began.

19. The system of claim 11 wherein upon completion of the service the application database transfers a form to the processing device and the provider fills in the form to identify services performed.

20. The system of claim 19 wherein the filled in form is transferred from the processing device to the application database for storage.
